(19) United States
(12) Patent Application Publication
(10) Pub. No.: US 2015/0072173 A1
(43) Pub. Date: Mar. 12, 2015

(54) RECHARGEABLE BATTERY PACK

(71) Applicants: Bo-Hyun BYUN, Yongin-si (KR); Ho-Jae CHO, Yongin-si (KR); Yeong-Mi KIM, Yongin-si (KR)

(72) Inventors: Bo-Hyun BYUN, Yongin-si (KR); Ho-Jae CHO, Yongin-si (KR); Yeong-Mi KIM, Yongin-si (KR)

(21) Appl. No.: 14/024,864

(22) Filed: Sep. 12, 2013

(51) Int. Cl. H01M 10/42

(52) U.S. Cl. CPC H01M 10/4257
USPC 429/7

(57) ABSTRACT

A rechargeable battery pack includes a rechargeable battery, a mount frame wrapping at least part of the rechargeable battery, an outer case wrapped around the mount frame, the outer case including a first case having a first lead unit protruding therefrom, and a second case having a second lead unit therefrom, the first lead unit and the second lead unit being inserted into and fixed to an inside of the mount frame, and a protective circuit module electrically connected to the rechargeable battery.

### CROSS-REFERENCE TO RELATED APPLICATION

Korean Patent Application No. 10-2013-0023990, filed on Mar. 6, 2013, in the Korean Intellectual Property Office, and entitled: “Rechargeable Battery Pack,” is incorporated by reference herein in its entirety.

### BACKGROUND

1. Field

The described technology relates generally to a rechargeable battery pack.

2. Description of the Related Art

Unlike a primary battery, a rechargeable battery can be recharged and discharged repeatedly. A small-capacity rechargeable battery is used for small portable electronic devices such as mobile phones, notebook computers, camcorders, and the like, and a large-capacity rechargeable battery is used as a motor-driving power source for a hybrid vehicle or the like.

Typical rechargeable batteries includes a nickel-cadmium (Ni—Cd) battery, a nickel-hydrogen (Ni—NH) battery, a lithium (Li) battery, a lithium ion (Li-ion) rechargeable battery, and the like. An operating voltage of a lithium ion rechargeable battery may be approximately three times higher than that of the nickel-cadmium battery or the nickel-hydrogen commonly used to portable electronic equipments. In addition, the lithium ion rechargeable battery may be widely used due to advantages in terms of higher energy density per unit weigh.

The rechargeable battery may use a lithium-based oxide as a positive active material, and a carbon material as a negative active material. In general, lithium-based rechargeable batteries may be classified into a liquid electrolyte battery and a polymer electrolyte battery depending on the kinds of electrolyte. A battery using the liquid electrolyte is referred to as a lithium ion battery and a battery using the polymer electrolyte is referred to as a lithium polymer battery.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery pack that includes a rechargeable battery, a mount frame wrapping at least part of the rechargeable battery, an outer case wrapped around the mount frame, the outer case including a first case having a first lead unit protruding therefrom, and a second case having a second lead unit therefrom, the first lead unit and the second lead unit being inserted into and fixed to an inside of the mount frame, and a protective circuit module electrically connected to the rechargeable battery.

The mount frame may include a first frame covering opposing sidewall portions of the rechargeable battery, a second frame coupled to the first frame and installed with the protective circuit module, and a third frame coupled to the first frame and including an inserting hole into which the first lead unit and the second lead unit are inserted.

The third frame may include a body frame coupled to the first frame, and a protrusion frame protruding from the body frame and including an inserting hole into which the first lead unit and the second lead unit are inserted.

The protrusion frame may include a first protrusion portion protruding on the body frame, a second protrusion portion protruding at a location spaced from the first protrusion portion on the body frame, and a cover unit forming the inserting hole by connecting the first protrusion portion with the second protrusion portion at a location spaced from a surface of the body frame.

The first lead unit and the second lead unit may be made of a nickel or stainless (SUS) material.

The first lead unit and the second lead unit may include at least two first lead units and at least two second lead units. Each of the first lead units and the second lead units may be bent in a direction toward the body frame.

One of the first lead units and one of the second lead units may be resistance-welded or laser-welded in a state where the one of the first lead units and the one of the second lead units are inserted into the inserting hole.

The cover unit may include a welding hole for welding of the one of the first lead units and the one of the second lead units inserted into the inserting hole.

The third frame may include a plurality of recess portions.

The recess portions may include a first recess portion into which the one of first lead units and the one of the second lead units are inserted, and a second recess portion including a depression portion at a bottom thereof.

The first case may further include a first fixing lead unit inserted into the second recess portion and coupled to the depression portion by an elastic force.

The second case may further include a second fixing lead unit inserted into the second recess portion and coupled to the depression portion by an elastic force.

### BRIEF DESCRIPTION OF THE DRAWINGS

Features will become apparent to those of skill in the art by describing in detail exemplary embodiments with reference to the attached drawings in which:

FIG. 1 illustrates a drawing schematically illustrating a rechargeable battery according to an exemplary embodiment.

FIG. 2 illustrates a partial exploded perspective view schematically illustrating a rechargeable battery according to the exemplary embodiment.

FIG. 3 illustrates a partial exploded perspective view seen from the bottom part of the rechargeable battery pack of FIG. 2.

FIG. 4 illustrates a perspective view schematically illustrating a third frame according to the exemplary embodiment.

FIG. 5 illustrates a side view of the third frame of FIG. 4.

FIG. 6 illustrates a partial exploded perspective view schematically illustrating a rechargeable battery according to another exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout

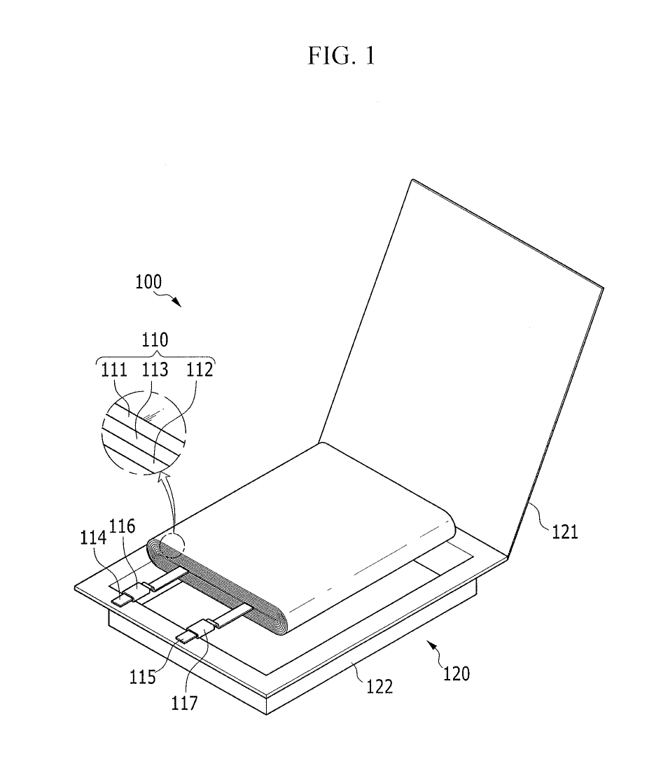

FIG. 1 illustrates a drawing schematically illustrating a rechargeable battery according to an exemplary embodiment.

As shown in FIG. 1, the rechargeable battery 100 may include an electrode assembly 110 and a pouch 120 accommodating the electrode assembly 110. The electrode assembly 110 may include a structure in which a positive electrode 111, negative electrode 112, and a separator 113 interposed between the positive electrode 111 and the negative electrode 112 may be spirally wound.

The separator 113 may be located between the positive electrode 111 and the negative electrode 112 to prevent a short and enable the movement of the lithium ions. The separator 113 may be formed of a polyethylene (PE) or polypropylene polymer film, or their multi-layers.

The positive electrode 111 may be electrically connected with a positive electrode tab 114. In addition, the negative electrode 112 may be electrically connected with a negative electrode tab 115. The positive electrode tab 114 may be bound with an insulation tape 116 for the positive electrode, and the negative electrode tab 115 may be bound with an insulation tape 117 for the negative electrode.

The pouch 120 may be a case that includes an upper case 121 and a lower case 122. At least one side of the upper case 121 and lower case 122 may be integrally connected. The pouch 120 may have a three-layer structure including a metal foil and an insulating film laminated on both sides of the metal foil, as an example.

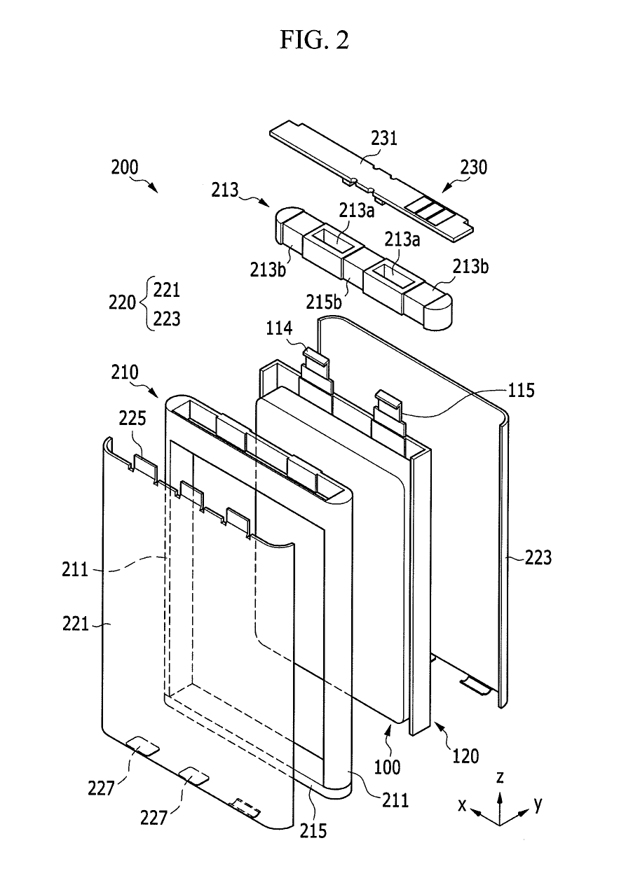

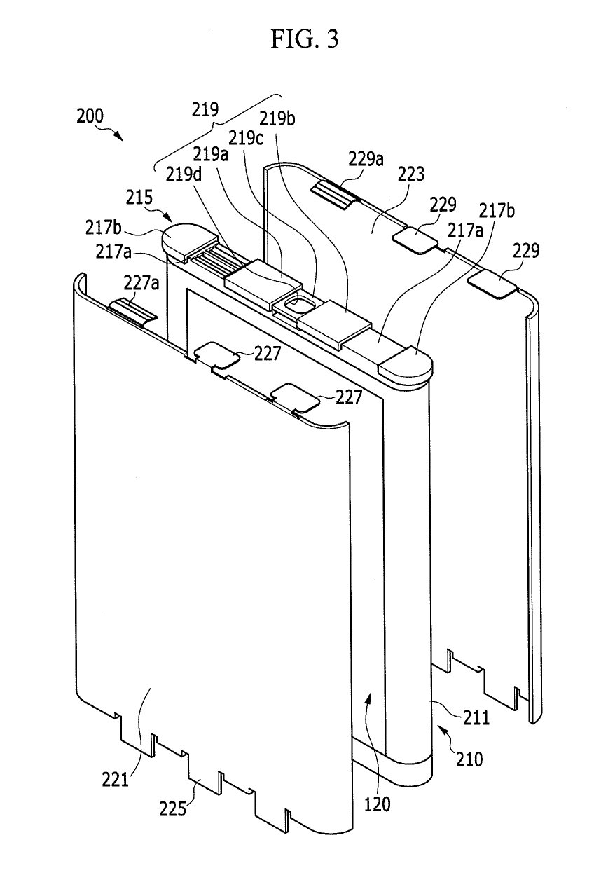

FIG. 2 illustrates a partial exploded perspective view schematically illustrating a rechargeable battery according to an exemplary embodiment, and FIG. 3 illustrates a partial exploded perspective view seen from the bottom part of the rechargeable battery pack of FIG. 2.

As shown in FIGS. 2 and 3, the rechargeable battery pack 200 according to this exemplary embodiment includes a rechargeable battery 100, a mount frame 210 wrapping at least part of the rechargeable battery 100, an outer case 220 installed to be wrapped around the mount frame 210 and including a first case 221 and a second case 223, and a protective circuit module 230 electrically connected to the rechargeable battery 100.

The rechargeable battery 100 is provided with the pouch 120 accommodating the electrode assembly 110. From one side of the pouch 120, an end portion of the positive electrode tab 114 and an end portion of the negative electrode tab 115 may be exposed to the outside. The pouch 120 may be a case with flexibility, and the pouch may be freely foldable in a state where the electrode assembly 110 is accommodated on the inside of the pouch 120. At least part of the rechargeable battery 100 may be wrapped by the mount frame 210.

The mount frame 210 may include a first frame 211 to cover two sidewall portions of the rechargeable battery 100, a second frame 213 to be installed on the first frame 211, and a third frame 215 to cover the bottom portion of the rechargeable battery 100.

The first frame 211 may be installed to be wrapped around at least two or more parts of the sides of the rechargeable battery 100.

The second frame 213 may be installed on the top of the first frame 211 and may be formed with a through-hole 213a in which the positive electrode tab 114 and the negative electrode tab 115 may be exposed in the direction of the protective circuit module 230. The outer surface of the second frame 213 may be formed with a plurality of inserting holes 213b. The term “inserting hole 213b” refers to a part in which a coupling protrusion 225 of the outer case 220 is inserted. The coupling protrusion 225 may be inserted into the inserting hole 213b and may be physically fixed using a separate fixing means. The bottom of the first frame 211 is provided with a third frame 215. Selectively, the third frame 215 may be removably installed on the first frame 211.

The third frame 215 may be coupled with a first lead unit 227 protruding from the first case 221 of the outer case 220, and may include an inserting hole 215a into which a second lead unit 229, which protrudes from the second case 223, is inserted. The inserting hole 215a may be formed at a central location of the length direction of the third frame 215. The inserting hole 215a may be formed for coupling in a state where the first lead unit 227 and the second lead unit 229 are inserted. Hereinafter, the inserting hole 215a will be described in more detail together with the third frame 215.

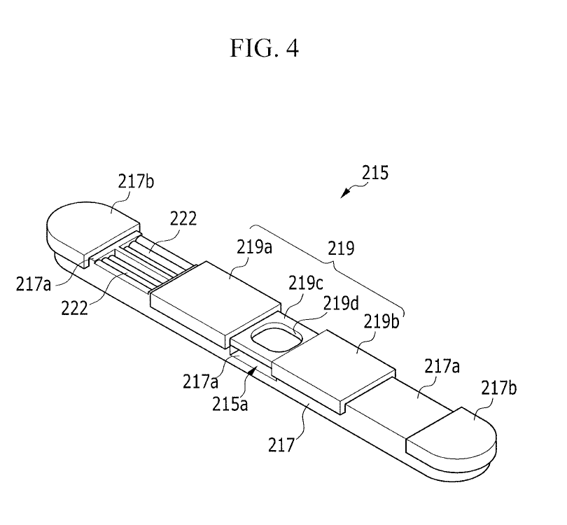

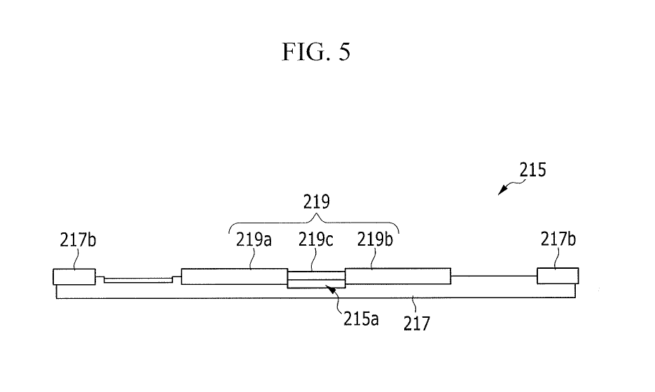

FIG. 4 illustrates a perspective view schematically illustrating a third frame according to the exemplary embodiment, and FIG. 5 illustrates a side view of the third frame of FIG. 4.

As shown in FIGS. 4 and 5, the third frame 215 may include a body frame 217 and a protrusion frame 219. The body frame 217 refers to a part directly coupled to the first frame 211. On the body frame 217, a plurality of protrusion frames 219 may be installed for formation of the inserting hole 215a.

The protrusion frame 219 may include a first protrusion portion 219a protruded on the body frame 217, a second protrusion portion 219b protruded on the body frame 217 at a location spaced apart from the first protrusion portion 219a, and a cover unit 219c to connect the first protrusion portion 219a and the second protrusion portion 219b.

The first protrusion portion 219a and the second protrusion portion 219b may protrude to be spaced apart from each other on the body frame 217. A recess portion 217a may be formed between the first protrusion portion 219a and the second protrusion portion 219b on the body frame 217b. A hook part 217b may protrude from the ends of both edges of the body frame 215b. Accordingly, the recess portion 217a can be formed at a central portion of the length direction of the third frame 215 and at both sides of the length direction of the third frame 215, respectively. Herein, three recess portions 217a formed into the third frame 215 will be described as an example. In other implementations, the number of recess portions 217a may vary according to the number of the protrusion portions.

In the exemplary embodiment, the recess portion 217a formed at the central portion of the third frame 215 among three recess portions 217a in the length direction may be formed with the cover unit 219c. One end of the cover unit 219c may be connected to the side of the first protrusion portion 219a and other end of the cover unit 219c may be connected to the side of the second protrusion portion 219b to cover the recess portion 217a formed at the central portion of the third frame 215. The inserting hole 215a into which the first lead unit 227 and the second lead unit 229 are inserted may be formed out of the first protrusion portion 219a, the second protrusion portion 219b and the cover unit 219c.

In the present exemplary embodiment, it will be illustrated as an example that the first lead unit 227 and the second lead unit 229 is fixed by a resistance welding or laser welding in a state where the first lead unit 227 and the second lead unit 229 are inserted into the inserting hole 215a. In other implementations, the first lead unit 227 and the second lead unit 229 may be fixed by a fitting within the inside of the inserting hole 215a.

The cover unit 219c may be formed with a welding hole 219d for welding of the first lead unit 227 and the second lead unit 229. The welding hole 219d may be formed on the upper side of the cover unit 219c such that the welding heat may be easily delivered to the first lead unit 227 and the second lead unit 229. The welding hole 219d may be formed in an oval shape corresponding to the length of the cover unit 219c to easily deliver the welding heat. In other implementations, the welding hole 219d may have other shapes such as a polygonal or circular. In the present exemplary embodiment, the first lead unit 227 and the second lead unit 229 may be resistance-welded or laser-welded.

As such, the first lead unit 227 and the second lead unit 229 may be fixed by welding heat in a state where they are inserted into the inserting hole 215a of the third frame 215, and thus, even if impact is delivered to the rechargeable battery pack 200, coupling durability of the outer case 220 is not deteriorated.

The first lead unit 227 and the second lead unit 229 may protrude in a state where they are bent at the edges of the first case 221 and the second case 223. The outer case 220 will be described in more detail below.

Referring again to FIGS. 2 and 3, the outer case 220 includes the first case 221 to protect one opened side of the mount frame 220 and the second case 223 to protect another opened side of the mount frame 220.

The first case 221 is installed to cover a first exposed side of the rechargeable battery 100 that is not protected by the mount frame 220. The second case 223 is installed to cover a second exposed side of the rechargeable battery 100 that is not protected by the mount frame 220. The first case 221 and the second case 223 may be installed on opposing sides of the rechargeable battery 100 to protect the rechargeable battery 100 from external impacts.

The first case 221 and the second case 223 may be made of metal materials and may be fixed by welding in a state where portions of the edges of the sides overlap to each other. The first case 221 and the second case 223 may be fixed by resistance welding or laser welding in a state where a portion of the corner of the first case 221 is located to be overlapped with a portion of the corner of the second case 223. In other implementations, the first case 221 and the second case 223 may be coupled with each other by a physical fitting. When the first case 221 and the second case 223 are coupled by such a fitting, the sides of the first case 221 and the second case 223 may be formed with an uneven parts (not shown) to be fixed using an elastic force. In addition, the first case 221 and the second case 223 can be coupled to the mount frame 210 with the fitting.

The first lead unit 227 inserted into the inserting hole 215a of the third frame 215 protrudes from the first case 221. A plurality of first lead units 227 may protrude to the external side of the edge of the first case 221. One of the first lead units 227 may be inserted into the inserting hole 215a formed on the third frame 215, and other ones of the first lead unit 227 may be inserted into the one of the recess portions 217a formed on the third frame 215. As such, the first lead unit 227 may be bent at the edge of the first case 221 in a direction of the third frame 215 such that the first lead unit may be easily inserted into the inserting hole 215a and the recess portion 217a of the third frame 215.

Another first fixing lead unit 227a may protrude from the first case 221 and may be bent along the length direction to be coupled to the third frame 215 by an elastic hook operation.

For combining with the first fixing lead unit 227a, one of recess portions 217a of the third frame 215 may be formed to have an uneven part 222.

As shown in FIGS. 4 and 5, a bottom of the recess portion 217a may be formed with a plurality of uneven parts 222. Accordingly, the end of the first fixing lead unit 227a may be inserted into the recess portion 217a and hook-coupled to the uneven part 222. Thus, the first case 221 may be fixed more stably.

The second lead unit 229 to be inserted into the inserting hole 215a of the third frame 215 may protrude from the second case 223.

At least two the second lead units 229 may protrude to the outside of the edge of the second case 223. One of the second lead units 229 may be inserted into the inserting hole 215a formed in the third frame 215 and another ones of the second lead units 223a may be inserted into the recess portion 217a formed in the third frame 215. As such, the second lead unit 229 may be bent at the edge of the second case 223 in a direction of the third frame 215 such that the second lead unit 229 may be easily inserted into the inserting hole 215a and the recess portion 217a of the third frame 215. The second lead unit 229 may be inserted in a state where the second lead unit 229 overlaps with the first lead unit 227 at the inserting holes 215a Thus, the first lead unit 227 and the second lead unit 227 can be fixed by welding.

The second fixing lead unit 229a may protrude from the second case 223. The second fixing lead unit 229a may be bent along the length direction to be hook-coupled to the third frame 215 by an elastic hook operation.

The second fixing lead unit 229a may be fixed to the uneven part 222 of the recess portion 217a of the third frame 215 described above by an elastic force. The second fixing lead unit 229a may be hook-coupled with the same recess portion 217a together with the first fixing lead unit 227a. A length protruding from the first fixing lead unit 227a and the length protruding from the second fixing lead unit 229a may each be formed to be less than half the length of the recess portion 217a such that the first fixing lead unit 227a and the second fixing lead unit 229a may both be hook-fixed to the one of the recess portions 217a. As a result, the first fixing lead unit 227a may be hook-fixed to a portion of the recess portion 217a by hook coupling, and the second fixing lead unit 229a may be hook-fixed by hook coupling together with the other portion of the recess portion 217a.

The first case 221 and the second case 223 of the present exemplary embodiment may be stably fixed to improve durability of the cases wherein the first lead unit 227 and the second lead unit 229 are coupled by welding, and the first fixing lead unit 227a and the second fixing lead unit 229a are hook-coupled.

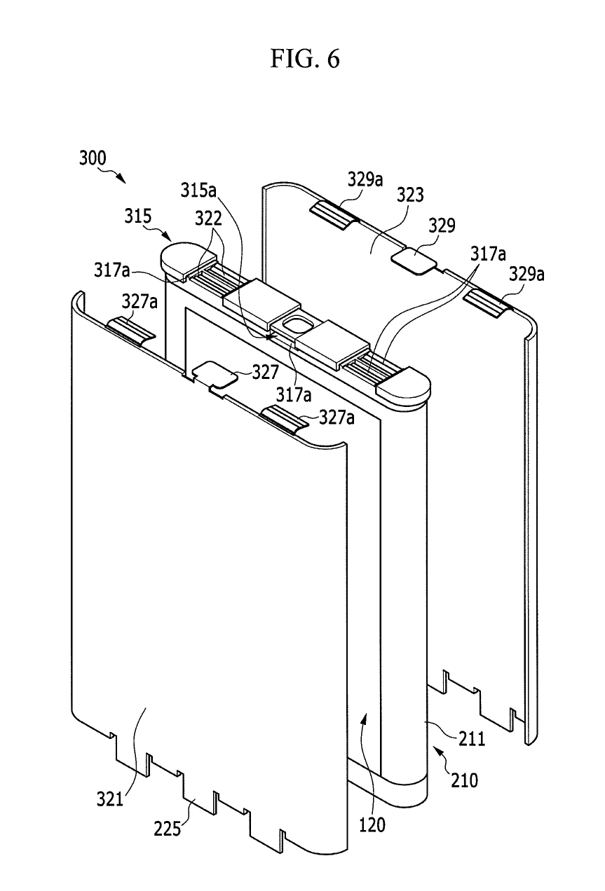

FIG. 6 is a partial exploded perspective view schematically illustrating a rechargeable battery according to another exemplary embodiment. The same reference numbers of FIGS. 1 to 5 refer as to the same members having the same functions. Hereinafter, detail description of the same reference numbers will not be repeated.

As shown in FIG. 6, in the rechargeable battery pack 300 according to the this exemplary embodiment, a first lead unit 327 protrudes from the center portion of the edge of the first case 321 in the length direction, and first fixing lead units 327a protrude from edges of the first case 321 at respective sides spaced from the center portion.

In addition, the second lead unit 329 protrudes from the center portion of the edge of the second case 323 in the length direction, and second fixing lead units 329a protrude edges of the second case 323 at respective sides spaced from the center portion.

The recess portions 317a into which uneven parts 322 are formed on the bottoms thereof may be present at the respective sides of the third frame 315 in the length direction.

Fixing of the first fixing lead units 327a and the second fixing lead units 329a with the uneven parts 322 from the recess portion 317a formed on the both sides of the third frame 315 may be achieved by the elastic hook function. In addition, the first lead unit 327 and the second lead unit 329 may be stably fixed by resistance welding or laser welding in a state where the first lead unit 327 and the second lead unit 329 are inserted into the inserting hole 315 of the third frame 315. As such, the first case 321 and the second case 323 can be hook-fixed to the mount frame 220 by welding or hook fixture to improve durability in response to external impacts.

By way of summation and review, rechargeable batteries may be provided with a protective circuit module to control charging and discharging. The protective circuit module may prevent over-charging and over-discharging of the rechargeable battery and may improve the safety and cycle-life of the rechargeable battery.

The rechargeable battery and protective circuit module may include a case to wrap the outside of the rechargeable battery, as a way to protect the rechargeable battery from external impact or the like. In addition, the protective circuit module may be physically coupled to a frame to protect the rechargeable battery.

When the case is physically coupled, there is a risk that the durability thereof may be deteriorated due to deformation of the fixed part in the event of an external impact.

Embodiments provide a rechargeable battery pack that may have enhanced durability with respect to external impacts of the rechargeable battery pack. A case to protect the rechargeable battery may be welded and hook-coupled to a mount frame to improve durability in response to such external impacts.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A rechargeable battery pack, comprising:
a rechargeable battery;
a mount frame wrapping at least part of the rechargeable battery;
an outer case wrapped around the mount frame, the outer case including a first case having a first lead unit protruding therefrom, and a second case having a second lead unit protruding therefrom, the first lead unit and the second lead unit being inserted into and fixed to an inside of the mount frame; and
a protective circuit module electrically connected to the rechargeable battery.

2. The rechargeable battery pack as claimed in claim 1, wherein the mount frame includes:
a first frame covering opposing sidewall portions of the rechargeable battery;
a second frame coupled to the first frame and installed with the protective circuit module; and
a third frame coupled to the first frame and including an inserting hole into which the first lead unit and the second lead unit are inserted.

3. The rechargeable battery pack as claimed in claim 2, wherein the third frame includes:
a body frame coupled to the first frame; and a protrusion frame protruding from the body frame and including an inserting hole into which the first lead unit and the second lead unit are inserted.

4. The rechargeable battery pack as claimed in claim 3, wherein the protrusion frame includes:
a first protrusion portion protruding on the body frame;
a second protrusion portion protruding at a location spaced from the first protrusion portion on the body frame; and
a cover unit forming the inserting hole by connecting the first protrusion portion with the second protrusion portion at a location spaced from a surface of the body frame.

5. The rechargeable battery pack as claimed in claim 4, wherein the first lead unit and the second lead unit are made of a nickel or stainless (SUS) material.

6. The rechargeable battery pack as claimed in claim 5, wherein:
the first lead unit and the second lead unit include at least two first lead units and at least two second lead units, and
each of the first lead units and the second lead units are bent in a direction toward the body frame.

7. The rechargeable battery pack as claimed in claim 6, wherein one of the first lead units and one of the second lead units are resistance-welded or laser-welded in a state where the one of the first lead units and the one of the second lead units are inserted into the inserting hole.

8. The rechargeable battery pack as claimed in claim 7, wherein the cover unit includes a welding hole for welding of the first lead unit and the second lead unit.

9. The rechargeable battery pack as claimed in claim 2, wherein the third frame includes a plurality of recess portions.

10. The rechargeable battery pack as claimed in claim 9, wherein the recess portions include:
a first recess portion into which the one of first lead units and the one of the second lead units are inserted, and
a second recess portion including a depression portion at a bottom thereof.

11. The rechargeable battery pack as claimed in claim 10, wherein the first case further includes a first fixing lead unit inserted into the second recess portion and coupled to the depression portion by an elastic force.

12. The rechargeable battery pack as claimed in claim 11, wherein the second case further includes a second fixing lead unit inserted into the second recess portion and coupled to the depression portion by an elastic force.
